(19) United States
(12) Patent Application Publication
(10) Pub. No.: US 2020/0240835 A1
(43) Pub. Date: Jul. 30, 2020

(54) SYSTEMS AND METHODS FOR EMBEDDED SENSORS WITH VARIANCE-BASED LOGIC

(71) Applicant: Washington University, St. Louis, MO (US)

(72) Inventors: Shantanu Chakrabartty, St. Louis, MO (US); Sri Harsha Kondapalli, St. Louis, MO (US); Xuan Zhang, St. Louis, MO (US)

(21) Appl. No.: 16/849,658

(22) Filed: Apr. 15, 2020

Related U.S. Application Data
(63) Continuation of application No. 15/718,642, filed on Sep. 28, 2017.
(60) Provisional application No. 62/400,807, filed on Sep. 28, 2016.

(51) Int. Cl. G01H 11/06; H04L 29/08; G01M 5/00

(52) U.S. Cl. CPC G01H 11/06; G01M 5/0066; H04L 67/12

(57) ABSTRACT

A variance-based substrate computing system is disclosed. The variance-based computing system includes a sensor configured to be embedded in a structure, the sensor further configured to generate an electrical output signal in response to a mechanical input, and a processor configured to receive the electrical output signal. The processor includes a measurement module configured to determine a variance of the electrical output signal about a base value, and a transformation module configured to generate a binary output signal based upon the variance.

### CROSS REFERENCE TO RELATED APPLICATION

This application is a Continuation of U.S. patent application Ser. No. 15/718,642, filed on Sep. 28, 2017, which claims the benefit of priority to U.S. Provisional Patent Application No. 62/400,807 filed on Sep. 28, 2016, the contents of which are hereby incorporated herein by reference for all purposes.

### STATEMENT REGARDING FEDERALLY SPONSORED RESEARCH & DEVELOPMENT

This invention was made with government support under grants 1405273 and 1550096 awarded by the National Science Foundation. The U.S. government has certain rights in the invention.

### BACKGROUND

Substrate computing systems include systems, such as sensors, computing or logic components, communication components, energy scavenging and energy storage components, and the like, that are capable of being integrated or embedded within a substrate. A substrate includes a structure or structural component, such as an aircraft wing, a section of a building, a part of a roadway, and the like. Substrate computing systems thus contribute to an infrastructural internet-of-things (i-IoT), in which a large number (e.g., hundreds, thousands, millions, or billions) of sensors are embedded within various civil and mechanical structures to sense, compute, and transmit information related to the structural health or integrity of the monitored structures to other computing or data processing systems.

To achieve a working i-IoT, however, it is necessary to integrate such sensors within substrates. For successful integration, the sensors are typically required operate without a separate power source for prolonged durations and may be required to occupy a small volume, so that the mechanical integrity of the substrate (e.g., a building or other structure) is not compromised.

Such power and space constraints may, however, affect the capacity of energy storage or energy harvesting devices be integrated with the sensor. As a result, a gap may exist between energy that can be scavenged from real-world mechanical structures and the energy density required for performing requisite computing operations.

In addition, although low power sensors have been designed in the past, such sensors often do not generate an output voltage sufficient for the application of standard binary logic operations. In other words, conventional low power sensors not generate output voltages sufficient to discriminate between a logic high signal and a logic low signal.

Variance-based logic (VBL) is applicable to devices and systems where the shape of the energy levels (or equivalently the momentum of the particles) can be changed. One such example is a system that is powered by scavenging energy from ambient sources. In this case, the asymmetry in the electrical impedance seen by the system ground and as seen by the energy transducer leads to different variances in voltage levels at the supply and at the ground potential. The difference in voltage variances could be used to implement VBL. Another example where VBL could be applicable are processors based on valleytronic devices where the curvature of the energy levels (or equivalently the momentum of the particle trapped in the energy level) could be changed to represent different logic levels. Our goal in this paper is to abstract out the physical level implementation of VBL and investigate the energy-efficiency limits of VBL as determined by thermal noise.

Embedded computing devices and sensors capable of low power operations and suitable for integration with one or more structures or structural components are therefore disclosed. More particularly, embedded computing devices and sensors utilizing variance-based logic are disclosed.

### BRIEF DESCRIPTION

One aspect of the present disclosure is variance-based substrate computing system. The variance-based computing system includes a sensor configured to be embedded in a structure, and a processor configured to receive the electrical output signal. The sensor is configured to generate an electrical output signal in response to a mechanical input. The processor includes a measurement module configured to determine a variance of the electrical output signal about a base value, and a transformation module configured to generate a binary output signal based upon the variance.

Another aspect is a method of variance-based computing. The method includes generating, by a sensor embedded in a structure, an electrical output signal in response to a mechanical input from the structure, receiving, by a processor embedded in the structure, the electrical output signal, determining, by the processor, a variance of the electrical output signal about a base value, and generating, by the processor, a binary output signal based upon the variance.

In yet another aspect, a variance-based substrate computing device is disclosed. The variance-based substrate computing device includes a circuit board configured to be embedded within a structure. The circuit board includes a sensor configured to generate an electrical output signal in response to a mechanical input from the structure and a processor communicatively coupled to the sensor. The processor is configured to determine a variance of the electrical output signal about a base value and generate a binary output signal based upon the variance.

Various refinements exist of the features noted in relation to the above-mentioned aspects. Further features may also be incorporated in the above-mentioned aspects as well. These refinements and additional features may exist individually or in any combination. For instance, various features discussed below in relation to any of the illustrated embodiments may be incorporated into any of the above-described aspects, alone or in any combination.

### BRIEF DESCRIPTION OF THE DRAWINGS

FIG. 1A is a perspective view of an example Internet of infrastructural things that includes a substrate computing system.

FIG. 1B is a perspective view of an example self-powered sensor.

FIG. 1C is a perspective view of an example self-powered sensor.

FIG. 1D is a perspective view of an example self-powered sensor.

FIG. 2A is a block diagram of an example method of self-powered sensor design.

FIG. 2B is latency diagram of an example power conditioning and conversion unit.

FIG. 2C is a block diagram of an example method of analog self-powered sensor design.

FIG. 2D is a block diagram of an example method of self-powered sensor design in which power conditioning and conversion are combined with digital logic to reduce system latency.

FIG. 3A is a graphical representation of an example high signal and an example low signal in a conventional binary logic circuit.

FIG. 3B is a graphical representation of an example high signal and an example low signal in a variance-based binary logic circuit.

FIG. 3C is a graph of an input-output curve associated with the graphical representation of FIG. 3A and a graph of an input-output curve associated with the graphical representation of FIG. 3B.

FIG. 4A is an example timing diagram of a conventional binary logic circuit.

FIG. 4B is an example timing diagram of a variance-based binary logic circuit.

FIG. 4C is an example image plot of the logic transitions of a conventional binary logic circuit.

FIG. 4D is an example image plot of the logic transitions of a variance-based binary logic circuit.

FIG. 5A is example embodiment of a logic gate.

FIG. 5B is an example embodiment of logic gate as a combination of a measurement module and a transformation module.

FIG. 5C is an example embodiment of a NOT logic gate.

FIG. 5D is an example embodiment of a circuit for measuring a signal mean used in forming the NOT logic gate of FIG. 5C.

FIG. 5E is an example embodiment of a circuit for transforming an output signal level based on a mean signal value used in forming the NOT logic gate of FIG. 5C.

FIG. 6A is an example embodiment of an equivalent implementation of variance-based NOT logic that is directly driven by an energy transducer.

FIG. 6B is an example variance measurement module corresponding to the NOT logic of FIG. 6A.

FIG. 6C is an example transformation module corresponding to the NOT logic of FIG. 6A.

FIG. 6D is an example input-output response of the variance-based NOT logic gate of FIG. 5C.

FIG. 7A is an example implementation of a NOR gate using variance-based logic.

FIG. 7B is a timing diagram associated with the implementation of the NOR gate using variance-based logic illustrated in FIG. 7A.

FIG. 7C is an example implementation of a latch using variance-based logic.

FIG. 7D is a timing diagram associated with the implementation of the latch using variance-based logic illustrated in FIG. 7C.

FIG. 8A is an example circuit used for analyzing performance of a logic gate.

FIG. 8B is an example diode threshold associated with the circuit of FIG. 8A.

FIG. 8C is an example transistor threshold associated with the circuit of FIG. 8A.

FIG. 8D is an example graphical representation of a transistor threshold associated with the circuit of FIG. 8A.

FIG. 8E is a graph summarizing logic latency as a function of input signal variance for various diode thresholds.

FIG. 9A is an example timing diagram associated with a synthesized counter circuit.

FIG. 9B is a table of logic cell parameters associated with an example processor.

FIG. 9C is a table of performance results associated with an example processor.

FIG. 10A is a statistical representation of binary logic states ‘0’ and ‘1’ using mean-based logic (MBL).

FIG. 10B is a statistical representation of binary logic states ‘0’ and ‘1’ using variance-based logic (VBL).

FIG. 10C is a schematic representation of the process of logic transition corresponding to mean-based logic (MBL).

FIG. 10D is a schematic representation of logic transition corresponding to variance-based logic (VBL).

FIG. 11 is numerically estimated figure-or-merit (FOM) corresponding to mean-based logic (MBL) and variance-based logic (VBL) for different values of Vₜₕ and σ₁.

FIG. 12 is a comparison of numerically estimated information capacities C as a function of the average probability of error pₐᵥₑ, corresponding to mean-based logic (MBL) and variance-based logic (VBL) for different values of Vₜₕ and σ₁.

### DETAILED DESCRIPTION

The present disclosure is directed to variance-based logic methods and systems. More particularly, the present disclosure is directed to sensors employing variance-based logic that are embedded in various structures, such as various civil structures and roadways. These sensors contribute to embedded computing systems, referred to herein as substrate computing systems, which are, likewise, embedded in various structures. As described herein, collections of substrate computing systems comprise infrastructural internets of things (or i-IoT).

The sensors described herein receive and convert a mechanical input (e.g., a vibrational input) to an electrical signal output. The electrical output signal is a relatively low voltage output that may not rise to a voltage level conventionally associated with a logic high output signal.

To accommodate the low voltage output signal produced by such a sensor, a substrate computing system, which includes a processor, is configured to receive the low voltage sensor electrical output signal as an input signal and to apply variance-based logic to the received input signal. Specifically, the processor determines a variance of the electrical output signal about a base value (e.g., zero volts) and generates a binary output signal based upon the variance. In the example embodiment, a variance about the base signal that is less than or equal to a threshold value causes the processor to generate a binary output signal corresponding to a logic low (or a binary value of zero), and a variance about the base signal that is greater than the threshold value causes the processor to generate a binary output signal corresponding to a logic high (or a binary value of one).

The systems and methods described herein therefore eliminates or circumvents the process of generating a stable binary signal level, which process may incur a significant latency and energy loss due to inefficiency of charge accumulation and multiplication circuits. As described herein, known techniques of directly exploiting the AC characteristics of the signal generated by a narrow band transducer (like a radio-frequency antenna or a piezoelectric resonator) as equivalent Boolean representation include AC-coupled logic, RF logic, and charge recovery logic. However, such techniques may suffer from a variety of disadvantages, including, for example: (a) high-energy efficiency and low-latency requires accurate phase synchronization between the Boolean logic levels (which could be time varying), and (b) the methods are not directly applicable to wide-band transducers or in cases where energy is simultaneously harvested from different transducers operating in different modes. The variance-based systems and methods for digital logic design described herein are more amenable to energy harvesting systems and use the statistical variance of the signal to represent different logic levels. Although described herein with respect to sensors and electrical output signals received from sensors, the variance-based logic systems and methods of the present disclosure may be used with other computing systems and may be responsive to any suitable inputs, such as from another data source, another computing device, a memory device, a communication device, etc.

Substrate computing systems are subject to size and power constraints. For example, substrate computing systems typically need to be small, so that they do not disturb the structural integrity of the substrate, or structure, within which they are embedded. As a result, the power sources associated with such systems are also small. Alternatively, as described herein, such systems may be self-powered. For instance, some substrate computing systems utilize an analog self-powering approach, in which computing operations are performed during every signal cycle (or selected signal cycles) and the results of computing operations stored on a non-volatile memory.

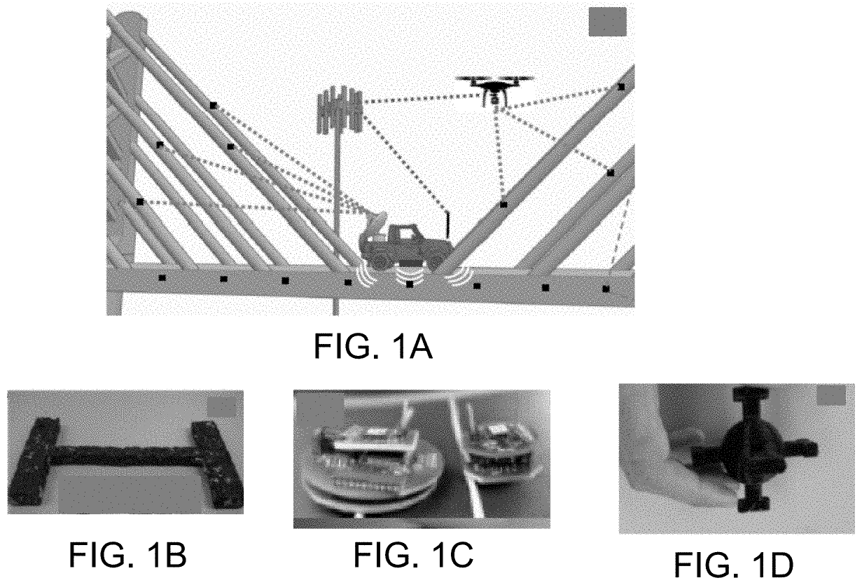

FIG. 1A is a vision of Internet of infrastructural things comprising of sensor systems that are embedded inside civil and mechanical infrastructures like concrete highway and large-span bridges. The sensors continuously monitor the health of the infrastructure and the stored data is retrieved using a vehicular or aerial wireless interrogator. FIGS. 1B-1C are examples of self-powered sensors designed and packaged for embedded monitoring the health of concrete structures. The sensor records the statistics of embedded strain and an ultra-low-power microcontroller is used for implementing and RFID interface for wireless data retrieval.

An advantage of an analog self-powering approach is that sensors may not experience downtime, as they are directly self-powered from a signal being sensed. The stored information is retrieved offline asynchronously using, for example, radio-frequency identification (RFID) interface. FIGS. 1B, 1C, and 1D show examples of i-IoT sensors that exploit analog self-powering to compute and store the statistics of strain-levels and strain-rates while embedded inside concrete structures.

FIG. 1A is a perspective view of a structure that includes a plurality of embedded substrate computing, or self-powered i-IoT, devices, such as i-IoT sensors. As shown, a vehicular platform (such as a maintenance truck or an aerial drone) equipped with an radio frequency identifier (or “RFID”) communication interface remotely powers the sensor's communication interface in real-time and retrieves the data from the plurality of embedded i-IoT sensors.

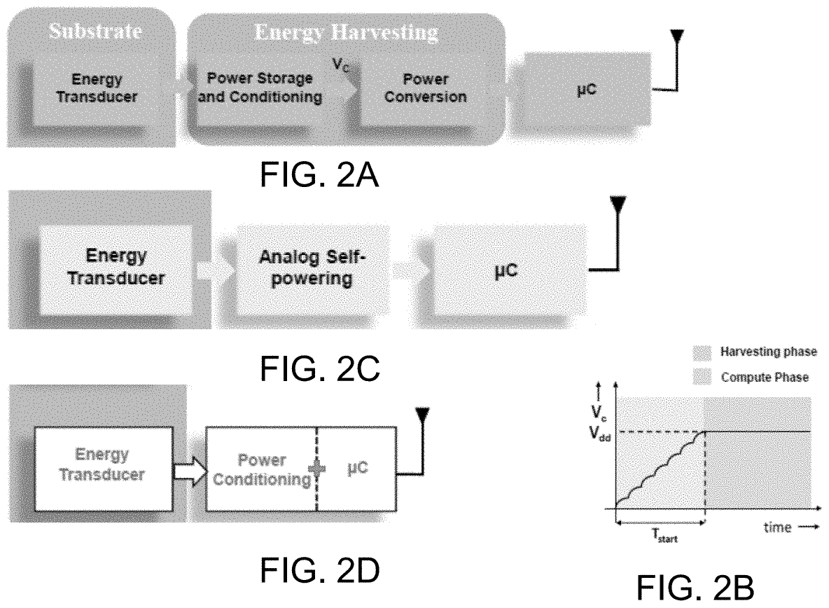

FIGS. 2A-D are methods for designing self-powered sensors: 2A is a modular approach where power conditioning and power conversion units are designed and optimized independent y of the microcontroller; 2B is the latency incurred by the power conditioning and conversion units for accumulating energy to activate the microcontroller; 2C is an analog self-powering approach where the physics of the transducer and analog non-volatile storage is used for continuous sensing; 2D is the proposed approach where the power conditioning and conversion are combined with digital logic to reduce system latency.

Power conditioning and energy buffering techniques may be used to design self-powered sensors, where a rechargeable energy storage device (e.g., rechargeable batteries or super-capacitors) are periodically refreshed using the energy scavenged from a sensed signal. In one embodiment, the operation of a sensor in different modules is shown in FIG. 2A. In this modular approach, a power harvesting unit transfers energy from a transducer attached to a substrate to an internal energy storage device, such as a capacitor or battery. FIG. 2B is a graph illustrating energy collected, in bursts or steps, over a period of time. A power conversion unit may be configured to regulate the flow of energy from the energy storage device to the load, which may comprise, as shown, a microcontroller. Such modular sensor design approaches improves the efficiency by optimizing each module and hence contributes to ultra-low power microcontrollers design and implementation as well as various power management algorithms (e.g., power duty-cycling algorithms).

However, there are limitations to modular sensor design approaches. For example, when a signal being sensed is infrequent, low-bandwidth, occurs in bursts, or is low energy, conventional methods of voltage and current multiplication and voltage and power regulation may not be directly applied or may be inefficient. Low energy signals arise in structural health monitoring (SHM) applications, where energy content is typically less than 1 μW and a maximum frequency may be 10 Hz.

In such cases, energy may be harvested, but energy accumulation may not be possible or may be such that computing operations are performed during every signal cycle (or selected signal cycles) and the results of computing operations stored on a non-volatile memory. An analog self-powering approach is illustrated at FIG. 2C. From a physical standpoint, analog self-powering devices depend upon coupling physics at the interface of a transducer and a non-volatile memory (like FLASH) of the microcontroller are used for sensing, computation, and storage.

In an example embodiment, and to illustrate, a truck having a span of one meter (measured from the front of the truck to the rear of the truck) that is moving at a speed of 50 mph amounts to an interrogation delay of approximately 30 m/s. As described herein, current RFID and other RF-based energy harvesting systems utilize a trickle-charging strategy to accumulate energy on a storage device (e.g., a capacitor or super-capacitor), which is sufficient to energize an ultra-low-power microcontroller. As illustrated at FIG. 2B, while the latency or processing delay of the microcontroller may be a function of the clock speed and hence the microcontroller energy-budget, the processor latency or processing delay may be exacerbated as a result of a trickle-charging energy gathering process.

In various embodiments, and as shown at FIG. 2D, a strategy to overcome such processor latency is to combine the process of energy accumulation with logic computation. Computing devices configured to implement variance-based digital logic facilitate the combination of energy accumulation with logic computation and are used, as described below, to synthesize new and existing microcontroller cores, such as the ARM Cortex M0 microcontroller core.

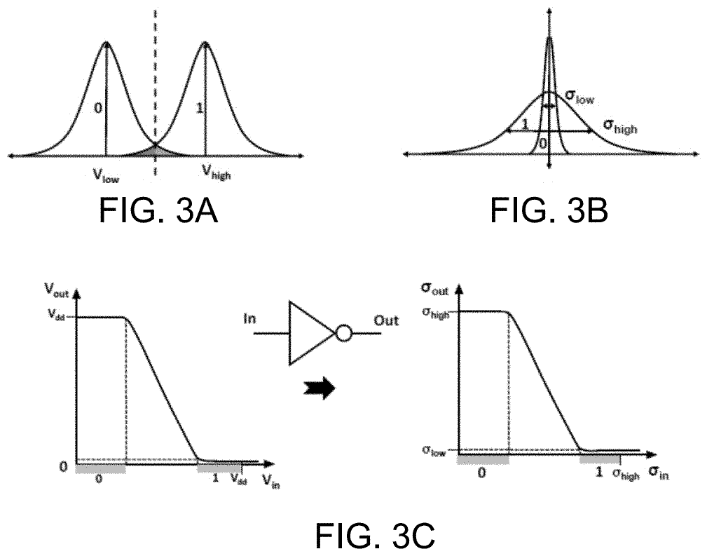

FIG. 3A represents a conventional approach for designing binary logic, where the two states (‘0’ and ‘1’) are rep resented by their signal levels V_{low} and V_{high}. The two signal levels are separated by an energy barrier represented by the noise margin and the probability of error is estimated by the area under the shaded area. FIG. 3B is a proposed approach for designing a variance-based logic where logic ‘0’ is represented by a signal with low variance and logic ‘1’ is represented by a signal with high variance. FIG. 3C is a graphical representation of the equivalence between the two logic representations illustrated using the input-output response of an inverter using the signal mean and the signal variance.

A Boolean circuit is typically represented by two states, such as ‘0’ and ‘1,’ or “high” and “low.” Each state is physically separated by an energy barrier (e.g. charge, spin phase-change), such as, for example, by two voltage levels, V_{low} and V_{high}. Because real world signals are noisy, these binary levels are statistically represented by their probability distributions centered about their respective means, V_{low} and V_{high}, as shown in FIG. 3A. The variance of each of the distributions captures the effect of noise and signal fluctuations, and a general practice in digital logic design is to separate the two signal levels, V_{low} and V_{high}, by a noise margin to ensure that any overlap between the distributions is minimal and is quantified by the cumulative probability of error (denoted by the shaded region in FIG. 3A). Historically, the goal of power harvesting and power conditioning modules (such as shown in FIG. 2A) has been to reliably generate one of the signal levels (typically V_{high}) for use as a supply voltage, V_{dd}, making V_{low} the ground reference. As described herein, however, the process of generating a stable V_{dd} incurs a significant latency due, for example, to trickle accumulation and multiplication of energy (as illustrated in FIG. 2B).

In light of the shortcomings associated with traditional Boolean logic in low-power systems, in various embodiments, and as shown at FIG. 3B, the signal variance is used, in the example embodiment, to represent different logic levels. A shown, a logic ‘LOW’ is represented by a probability density function (or “PDF”) with a small variance and a logic ‘HIGH’ is represented by a PDF with a large variance. In the example embodiment, the means for both of the distributions are concentrated around a voltage level of zero.

Thus, from an energy standpoint, a ‘LOW’ signal value corresponds to an energy sink, such as a ground plane, whereas a ‘HIGH’ signal value corresponds to a random electrical output (sensed) signal with finite energy fluctuations (or statistical variance). In various embodiments, a logic ‘HIGH’ is available for an energy harvesting system by way of access to a viable energy source of ‘HIGH’ variance (e.g., a vibrational energy source, such as a motion of a building or vibrations induced in a roadway as vehicles travel over the surface of the roadway).

In the example embodiment, the implementation of fundamental logical functions using variance-based logic obviates or reduces a need for power harvesting and power regulation modules. FIG. 3C shows an equivalent mapping between a conventional logic and a variance-based logic for a basic inverter. As shown, a variance-based inverter logic is represented in a manner similar to a conventional inverter, except, the ‘HIGH’ and ‘LOW’ levels traditionally centered about distinct values are represented by variances (of σ_{high} and σ_{low}), which are centered around a single value, such as, in the example embodiment, a zero voltage.

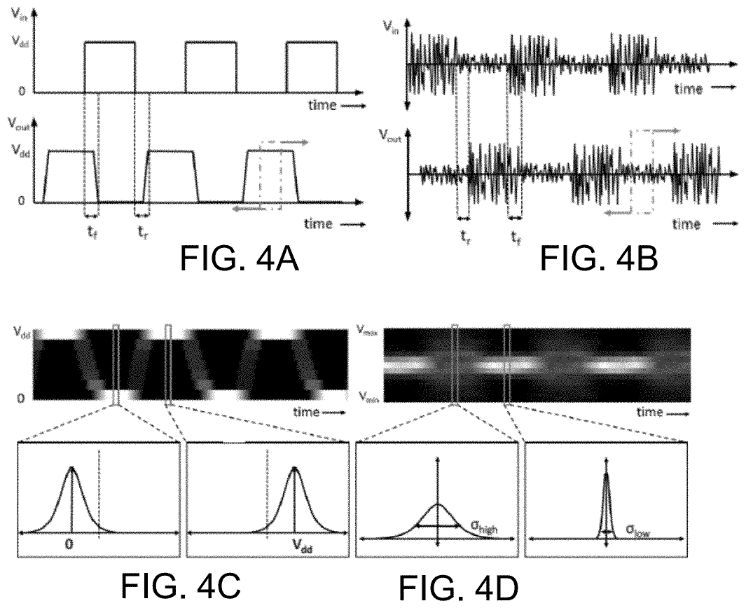

FIGS. 4A and 4B are representative timing diagrams corresponding to, respectively, conventional binary logic and the proposed variance-based logic. FIGS. 4C and 4D are visualizations of the logic transitions using an image plot showing the switching between two signal distributions.

FIGS. 4A, 4B, 4C, and 4D illustrate a comparison of a timing diagram corresponding to conventional (non-zero) logic and a timing diagram for variance-based logic. The transition between the different logic levels are shown in FIGS. 4A and 4B and denoted by rise and fall times. For the variance-based logic, as shown at FIG. 4B, the transition occurs between signals with low and high statistical variances. FIGS. 4C and 4D correspond to FIGS. 4A and 4B but depict spectrographic representations of the timing diagrams.

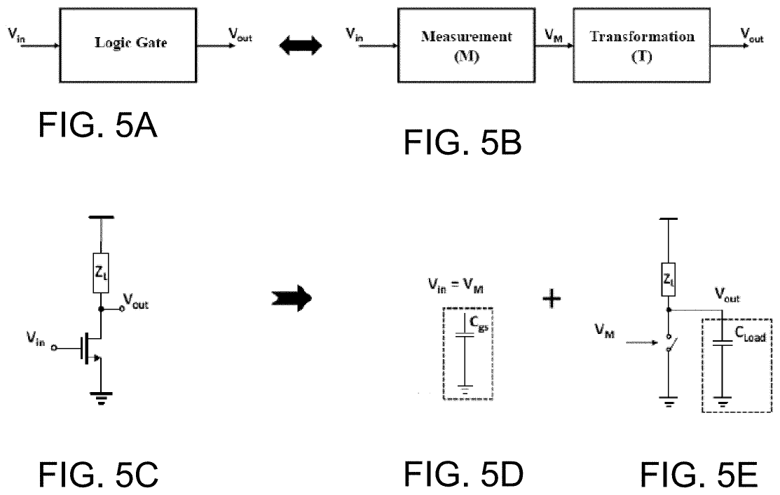

FIG. 5A is an example implementation of a logic gate. FIG. 5B is an example implementation of a logic gate as a combination of a measurement module and a transformation module. FIG. 5C is an example implementation of a NOT logic gate using a conventional approach. FIG. 5D is an example implementation of a NOT logic gate formed using a circuit for measuring the signal mean. FIG. 5E is an example implementation of a circuit for transforming the output signal level based on the mean.

FIG. 5A illustrates a generic architecture of any combinational logic circuit. As shown at FIG. 5B, this architecture includes a measurement module and a transformation module. The measurement module initially determines the state of an electrical output signal, which for conventional logic, includes measuring the signal mean. In a CMOS implementation, the signal mean is measured, for example, by averaging the signal on a capacitor (typically the gate-capacitance of a MOSFET transistor), as shown in FIG. 5D for an inverter in FIG. 5C.

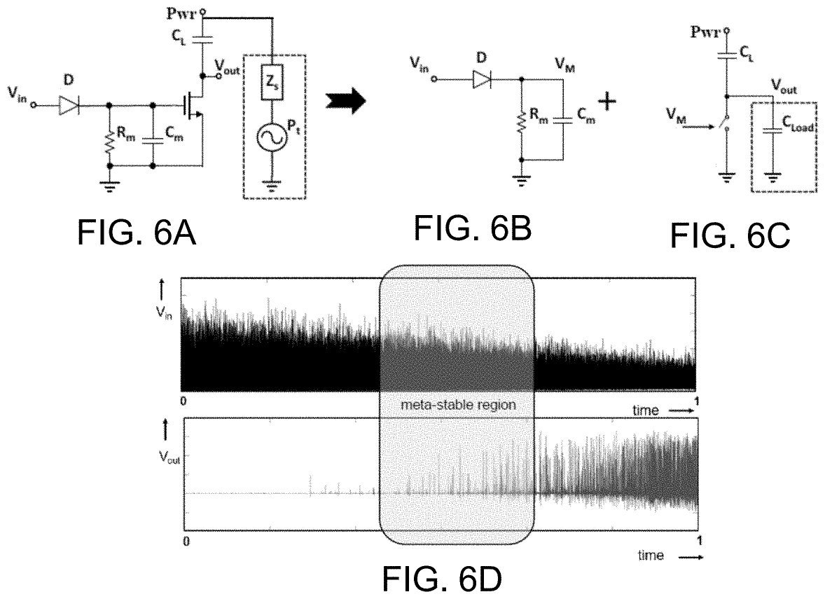

In the example embodiment, the transformation module generates the output signal state by selectively switching ON and OFF the load Z_{L}, as shown in FIG. 5E. This is illustrated for a conventional NOT gate where the switch is implemented using an NMOS transistor and the load Z_{L} includes a PMOS transistor. For variance-based logic, the measurement module may determine the state of the electrical output signal variance (high or low) in several ways. For example, the measurement module may measure the energy of the electrical output signal using a rectifier and/or use a peak detector to track the maximum value of the electrical output signal. FIG. 6A shows a half-wave rectifier stage (formed by the diode D, resistor Rₘ, and a capacitor Cₘ) that could be used for measuring the variance of the electrical output signal.

FIG. 6A is an equivalent implementation of a variance-based NOT logic that is directly driven by an energy transducer. FIGS. 6B and 6C show the corresponding variance measurement module and the transformation module, respectively. FIG. 6D is an input-output response of the variance-based inverter showing the meta-stable region where the electrical output signal variance transitions from low to high.

The transformation module for a variance-based logic circuit couples or decouples a power supply (e.g., P_{wr}) to the output in response to the determination or acquisition of a variance based logic level. In the example embodiment, this occurs through a by-pass capacitance C_{L}.

Moreover, since the power supply directly couples to the energy transducer, a relatively large variance is induced, and the output signal is, as a result, associated with a low variance if the switch is ON or a high-variance if the switch is OFF. In addition, a resistance, such as the resistance labeled “Rₘ” in FIG. 6B, is added to a variance-based logic circuit, to implement a leakage or “bleed” functionality as a mechanism for erasing or resetting a variance measured during a previous measurement cycle prior to measurement during a subsequent cycle. In the example embodiment, the bleed resistor is implemented using a reverse leakage diode. FIG. 6D shows the equivalent meta-stable response of an inverter implemented using the variance-based logic where the switch in FIG. 6B is implemented using an NMOS transistor. As shown, when the sensed electrical output signal variance is ‘HIGH’, the variance is ‘LOW.” In addition, as the electrical output signal variance transitions from ‘HIGH’ to ‘LOW’, the variance undergoes a “statistical” meta-stability (similar to a conventional meta-stable response), as shown in the highlighted region, before transitioning to the ‘HIGH’ variance. Many of the properties observed in a conventional logic circuit thus carry over to the variance-based logic, albeit in a statistical sense.

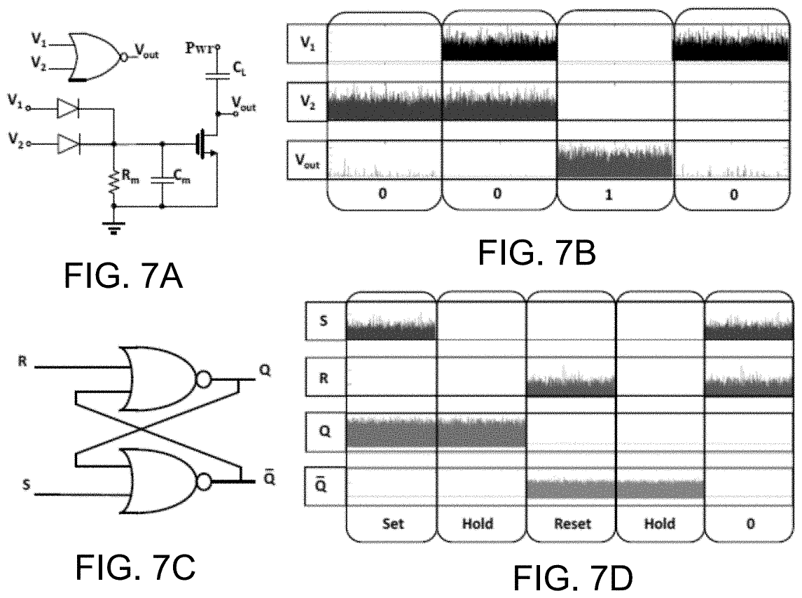

FIG. 7A is an implementation of a NOR gate using variance-based logic. FIG. 7B is an illustration showing the timing diagram obtained through a SPICE simulation of an implementation in 180 nm CMOS process for the implementation of the NOR gate illustrated in FIG. 7A. FIG. 7C is an implementation of a latch using variance-based logic. FIG. 7D is an illustration showing the timing diagram obtained through a SPICE simulation of an implementation in 180 nm CMOS process for the implementation of the latch illustrated in FIG. 7C.

Although FIGS. 5A, 5B, 5C, and 5E and FIGS. 6A, 6B, 6C, and 6D illustrate aspects of a basic variance-based measurement and transformation circuit, variance-based logic is utilized to implement other logic functions, such as a NOR function or a latch function. A variance-based NOR function is shown at FIG. 7A, and a latch function is shown at FIG. 7C. Timing diagrams for each of the NOR function and latch gate illustrated in FIG. 7A and 7C are shown at FIGS. 7B and 7D, respectively. In the examples of FIGS. 7A, 7B, 7C, and 7D, the variance-based logic is single-ended in that only one of the outputs from an energy transducer is utilized. However, many energy transducers (e.g., piezoelectric transducers and RF antennas) are fully differential. Such devices utilize fully differential variance-based logic.

Variance-based logic can be implemented using different types of measurement and transformation circuits, and as a result, different types of measurement and transformation circuits can be modeled and analyzed. For example, and with reference to the circuit topology shown at FIG. 6A, a variance-based logic circuit for a NOT gate is described.

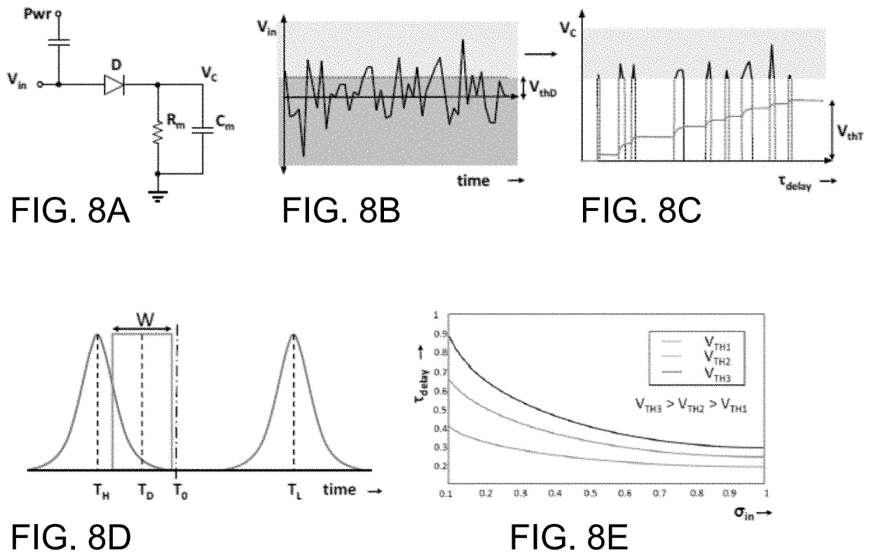

FIG. 8A is a fundamental circuit used for analyzing the performance trade-off of the proposed variance-based logic (VBL). FIG. 8B shows data associated with the fundamental circuit where the logic latency is determined by the diode threshold. FIG. 8C shows data associated with the fundamental circuit where the logic latency is determined by the transistor threshold. FIG. 8D is the distribution of the latency (time to reach the threshold Vₜₕ₂) for different input signal variances. FIG. 8E shows the performance trade-off showing the inverse relationship between the logic latency and input signal variance.

Accordingly, and in this example, a performance trade-off (speed and power-dissipation) can be determined based upon an analysis of several factors, such as, for example: (a) how quickly and efficiently the input signal variance may be measured using the circuit in FIG. 5C; (b) how quickly and efficiently the measurement may be erased after each cycle; and (c) how quickly and efficiently the output signal variance may be switched from high to low. These three factors can be modeled using a generic equivalent circuit, as shown at FIG. 8A. This example assumes that the signal generated by the energy transducer can be statistically represented by an additive white Gaussian noise source with a variance, σᵢₙ.

More particularly, the coupling capacitor, C_{L}, of the previous stage may drive the half-wave rectification circuit formed by the elements labeled D, Rₘ and Cₘ. The diode D can be modeled by its threshold voltage, V_{thD}, and its ON resistance, R_{D}. An input waveform at the terminal, Vᵢₙ, is shown at FIG. 8B where the voltage V_{C} is accumulated over several cycles for a duration of T_{delay}. If V_{C} reaches the threshold voltage of an NMOS transistor, V_{thT}, then the switch (as shown at FIG. 6C) powers on and pulls the output down to a low-variance state.

A processing latency can be determined and associated with a particular logic function based upon the sum of the respective rise-times and fall-times associated with the logic function. The rise-time is determined by the time taken for an input signal with variance, σᵢₙ, to reach V_{thT}, as shown in FIGS. 8B and 8C. The fall-time is determined by the time taken by the resistor, Rₘ, to discharge the capacitor, Cₘ and is illustrated by W in FIG. 8C. FIG. 8D illustrates a plurality of “trade off” curves, showing an inverse relationship (or “trade off”) between the latency and the input signal variance, σᵢₙ, or its energy. Different threshold voltages V_{thD} and V_{thT} result in different output values. These trade-off curves can be used to quantify the worst-case latency and worst-case power dissipation for different magnitudes of input variance or signal energies. These parameters can also be used for synthesizing a processor core using existing EDA tools, as described below.

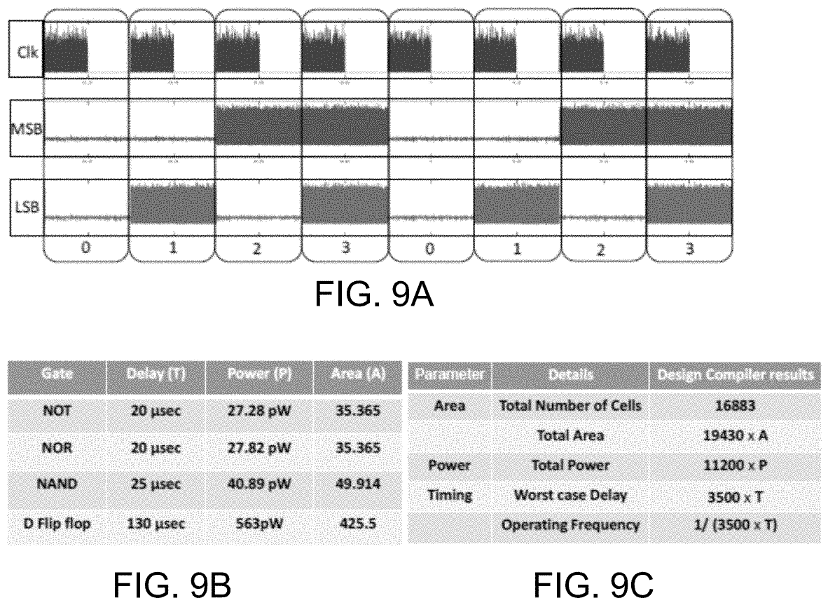

FIGS. 9A-9C show examples of logic synthesis using the proposed variance-based logic (VBL): FIG. 9A shows results from a synthesized counter; FIG. 9B shows logic cell parameters used for synthesizing an ARM cortex M0 considering Rₘ=4 GΩ, Cₘ=2 fF and σᵢₙ=1; and FIG. 9C shows performance results post-synthesis of the ARM cortex processor showing that the proposed variance-based logic is compatible with existing synthesis and optimization tools.

Accordingly, the compatibility between variance-based logic and digital logic synthesis flow can be verified as described below. In an example embodiment, a simple two bit counter is synthesized and verified, and the synthesis extended to a reasonably complex microcontroller, such as an ARM Cortex M0. A minimum viable set of logic gates consisting of an inverter, NAND, NOR, latch, and D-flip-flop (DFF) are constructed. Each gate is characterized using SPICE simulations incorporating circuit and transistor parameters corresponding to a standard CMOS process. The example embodiment incorporates a 180 nanometer CMOS process, and critical performance parameters, such as power dissipation, cell area, and delay, are extracted, as summarized and shown in the table of FIG. 9B. The performance parameters are used to compile a design library database, which is supplied or fed into a synthesis tool. Power and delay models are adopted according to and as defined by the syntax required by the EDA library files. Various model attributes are captured using a look-up table, where each table-entry corresponds to an input transition delay and its respective output load capacitances.

A two bit synchronous counter is synthesized to verify the framework using a suitable compiler, such as a Synopsys Design Compiler. A Verilog-based behavioral model of the counter is provided as an input to the synthesis tool along with the library corresponding to the variance-based logic. A gate-level netlist generated by the tool is used to simulate the counter in SPICE. FIG. 9A shows the simulated waveform conforming to the operation of the two bit counter.

Such an approach is extended to the synthesis of an ARM Cortex M0 processor, which is a 32-bit low-power microprocessor having a three-stage pipeline and Thumb ISA support. The RTL-level description of the core is used as the input and the full synthesis is completed without any modification to the source code. FIG. 9C summarizes the performance of such a synthesized core and presents the worst-case power, delay, leakage, and area data, normalized by the performance metric of a single logic cell. In various embodiments, different implementations of the variance-based logic yield different performance metrics and therefore change the overall performance of the synthesized core.

In summary, although energy harvesting circuits and digital logic circuits are typically designed and optimized independently, in various embodiments an i-IoT processor that seamlessly integrates energy harvesting and scavenging circuits with digital logic is described. In this way, an i-IoT processor overcomes temporal latency in accumulating and multiplying energy from one or more ambient sources. In the example embodiment, a variance-based logic design is implemented that defines the logic levels according to differences in a statistical variance of a signal rather than according to the statistical mean of a signal.

As a result, the logic cells described herein can be powered directly by (and operate on) a signal generated by an energy transducer. Another benefit of variance-based logic is that the reciprocity of the energy transducer (such as an RF antenna) is used to wirelessly transmit logic-state information. Variance-based processors designed and implemented as described herein are applied to the next generation of embedded i-IoT sensors for monitoring various substrates or structures without downtime and without maintenance. Such processors are further interfaced with existing and future i-IoT networks. Moreover, the variance-based logic systems and methods described herein may be used in any suitable computing environment, whether or not connected to sensors, as an alternative, or addition, to traditional logical systems.

### EXAMPLES

### Example 1: Variance-Based Logic and Mean-Based Logic Energy Efficiency

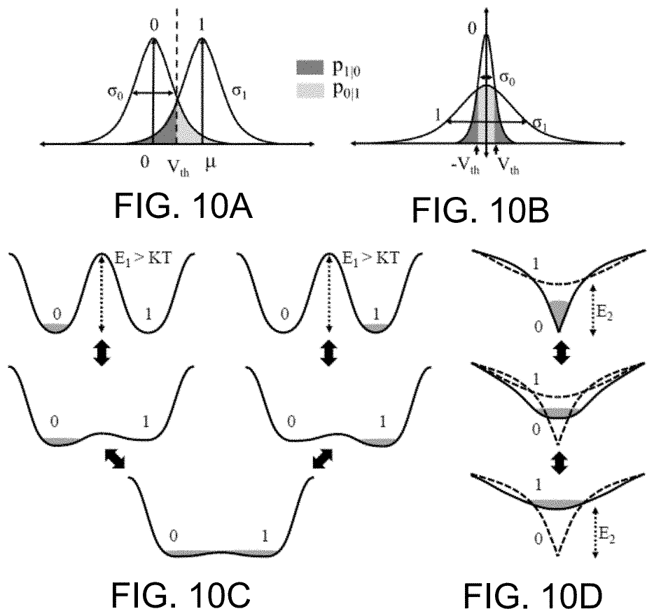

The energy-efficiency of variance-based logic (VBL) can be compared to the traditional mean-based logic (MBL) by visualizing the process of logic transition, as shown in FIGS. 10C and 10D. For a specific implementation of MBL, the logic transition can be realized by transferring electrons from one potential well to another, as shown in FIG. 10C. The height of the energy barrier E₁ which determines the reliability of a logic state is set to be at least E₁>KT, where K is the Boltzmann's constant and T is the temperature at which the MBL device is operated. During the logic transition (0 to 1 for example), the energy barrier is lowered and the potential wells are reshaped in a way that the electrons move to the potential well corresponding to logic 1. The energy barrier E₁ is then restored and held until the next transition. Assuming irreversible computation and adiabatic transport of the electrons between the potential wells, the energy dissipated per logic transition or a bit (E_{MBL}) for MBL, can be estimated to be twice the height of energy barrier (E_{MBL}=2×E₁). On the other hand, in a VBL device (as depicted in FIG. 10D) the electrons are either constrained in a narrow potential well (a low variance state ‘0’) or the electrons are relatively free to move around in a broader potential well (a high variance state ‘1’). Transition between the logic states in VBL involves changing the shape of the potential well and hence involves adding or subtracting a fixed amount of energy E₂ from the system, as shown in FIG. 10D. Irrespective of the operating conditions for an irreversible computation, the amount of energy required for each transition in case of variance-based logic is approximately E₂ and could be significantly lower than E₁.

Estimation of energy-dissipation per bit: The information capacity for MBL and VBL is estimated by first estimating the average probability of error p_{avg} that is incurred in measuring the two logic levels. This can be estimated as:

p_{avg}=p₀p_{1|0}+p₁p_{0|1} Equation 1:

where p₀, p₁ are a priori probability for logic state to be ‘0’ or ‘1’, and p_{1|0}, p_{0|1} are conditional probability that captures incorrect measurement of the logic state. In an MBL representation as shown in FIG. 10A, a threshold Vₜₕ could be used to distinguish between the logic levels in which case p_{1|0}, p_{0|1}, is given by the overlap between the distributions. Assuming equal a priori probability p₀, p₁=0.5 and the conditional distributions to be Gaussian with respective means 0 and μ and variances σ₀² and σ₁², the average probability of error can be estimated as:

$$\begin{matrix}{p}_{avg , MBL} = \frac{1}{4} [ erfc ( \frac{μ - {V}_{t h}}{\sqrt{2} {σ}_{1}} ) + erfc ( \frac{{V}_{t h}}{\sqrt{2} {σ}_{0}} ) ] & Equation 2 \\ where , & \\ erfc ( x ) = \frac{2}{\sqrt{π}} {\int }_{π}^{∞} {e}^{- {t}^{2}} dt . & Equation 3\end{matrix}$$

In case of VBL, the variances σ₀² and σ₁² corresponding to the two logic states could be measured by comparing the magnitude of the signal with respect to a threshold ±Vₜₕ. The probability of error (p_{err,VBL}) is determined by the shaded region as shown in FIG. 10B. Following Equation 1 and assuming equal a priori probabilities, the average probability of error p_{err,VBL} can be estimated as:

$${p}_{avg , VBL} = \frac{1}{2} [ 1 - erfc ( \frac{{V}_{t h}}{\sqrt{2} {σ}_{1}} ) + erfc ( \frac{{V}_{t h}}{\sqrt{2} {σ}_{0}} ) ] . \qquad Equation 4$$

The information transfer rate can be estimated by applying Shannon's capacity equation to a binary asymmetric channel with error probabilities p_{0|1} , and p_{1|0} and is given by:

C(p_{0|1},p_{1|0})=f_{c}[1+p₁{p_{0|1}ln(p_{0|1})+p_{1|1}ln(p_{1|1})}+p₀{p_{1|0}ln(p_{1|0})+p_{0|0}ln(p_{0|0})}] Equation 5:

where f_{c} is the rate (or equivalently the speed) at which the logic state is measured.

The next step towards determining the energy efficiency of MBL and VBL is to estimate the energy dissipated during the process of logic transition. For an MBL, the energy is dissipated during charging and discharging the sampling capacitor (Cₘₑₐₛ) to voltage μ at a rate of f_{c} is given by:

P_{MBL}=f_{c}×½Cₘₑₐₛμ² Equation 6:

For a VBL, the power dissipation would be given by the difference in the signal variance corresponding to the two logic states and is given by:

P_{VBL}=f_{c}×Cₘₑₐₛ(σ₁²−σ₀²). Equation 7:

The power dissipated per bit (or the figure-of-merit (FOM) for comparison) is the given by:

$${FOM}_{M B L , V B L} = \frac{{P}_{M B L , V B L}}{C ( {p}_{0 \vert 1} , {p}_{1 \vert 0} )} . \qquad Equation 8$$

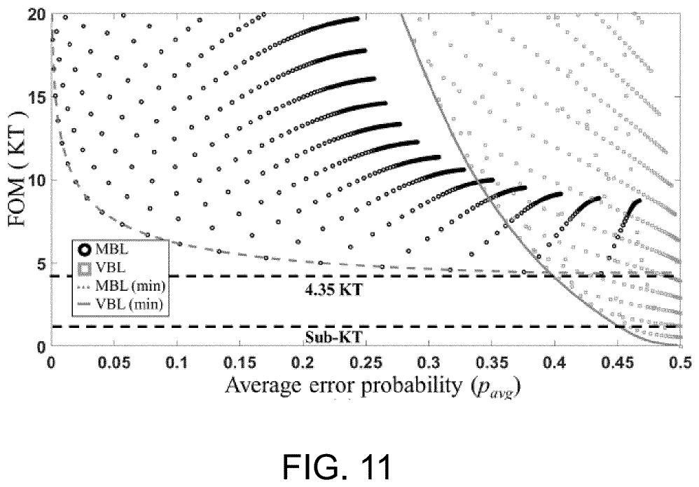

Note that the FOM is a function of probabilities p_{1|0} and p_{0|1}, which in turn depend on the variances σ₀², σ₁² corresponding to the logic states 0 and 1 respectively. Since our objective is to determine the fundamental limits for MBL and VBL as constrained by thermal noise, we will assume σ₀²=KT/Cₘₑₐₛ. FIG. 11 compares the FOM numerically estimated for MBL and VBL using Equations 2-8 and for different values of Vₜₕ and σ₁², respectively. The figure shows that for the FOM for MBL is bounded from below and approaches a fundamental limit of 4.35 KT/bit. Provided below is a brief derivation of this limit.

Assuming a binary symmetric channel with σ₁=σ₀, the Shannon capacity equation given by Equation 5 can be rewritten as:

C_{MBL}(p)=fhd c[1+p log₂ p+(1−p)log₂(1−p)]. Equation 9:

Defining Δp as Δp=p_{avg}−0.5 and using a Taylor series expansion of C_{MBL} around p_{avg}=p=0.5, Equation 9 leads to:

$${{C}_{M B L} ( Δp ) \vert}_{p \approx 0.5} = C ( p ) + \frac{{C}^{′} ( p )}{1 !} Δ p + \frac{{C}^{″} ( p )}{2 !} Δ {p}^{2} + … = \frac{2}{ln 2} {{f}_{c} ( Δ p )}^{2} . \qquad Equation 10$$

Assuming that the variance of measurement

$${σ}_{0}^{2} = {σ}_{1}^{2} = \frac{K T}{{C}_{m e a s}}$$

as determined by thermal noise and

$${V}_{t h} = \frac{μ}{2} ,$$

Δp is given by:

$$Δ p \approx \frac{g ( 0 ) μ}{2} = \frac{μ}{2 \sqrt{2 π} σ} = \frac{μ}{2 \sqrt{2 π K T / {C}_{m e a s}}} \qquad Equation 11$$

where g(0) is the Gaussian distribution function. Using Equation 10, the capacity is given by:

$${{C}_{M B L} \vert}_{p \approx 0.5} = \frac{{μ}^{2}}{( 4 π ln 2 ) \frac{K T}{{C}_{m e a s}}} {f}_{c} \qquad Equation 12$$

which leads to the fundamental FOM limit as:

$${FOM}_{MBL \vert min} = \frac{{P}_{M B L}}{{C}_{MBL \vert p \approx 0.5}} \approx 4.35 KT \text{/} bit . \qquad Equation 13$$

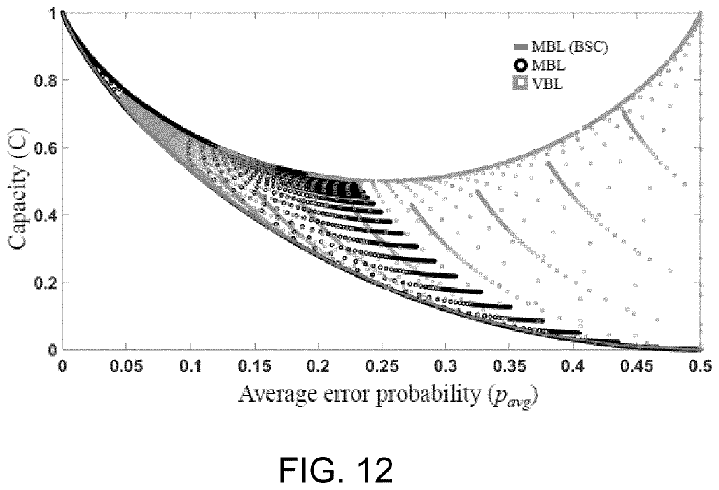

This limit has been verified using numerical simulation and the results are summarized in FIG. 11. It can be also seen in FIG. 11 that the FOM limit for VBL could be lower than the MBL limit and in some cases the FOM approaches sub-KT per bit. For VBL sub-KT per bit limit is achieved when the respective variances σ₀ and σ₁ are approximately equal (implying p_{avg}≈0.5) and the threshold Vₜₕ samples only the tails of the distribution, as shown in FIG. 10B. To understand why VBL can achieve sub-KT per bit limit, in FIG. 12 we compare the channel capacity C(p_{0|1},p_{1|0}) for MBL and VBL, numerically estimated for different values of Vₜₕ and σ₁. FIG. 12 shows that while for MBL the information capacity approaches zero when the p_{avg}≈0.5, this is not the case for some instances of VBL when Vₜₕ is located around the tails of the distribution.

### Example 2: Variance-Based Logic and Mean-Based Logic Signal-to-Noise Ratio

One of methods to approach the fundamental limit of energy-dissipation or MBL is to use error-correcting codes to compensate for high p_{avg}. A more practical approach would be to first boost the signal-to-noise ratio (SNR) of the measurement through repeated sampling and statistical averaging. Given N independent and identically distributed (iid) random samples x₁, x₂, . . . x_{N} from a distribution with mean μ and variance σ², the sample mean (\hat{x}) is defined as:

$$\hat{x} = \frac{{\sum }_{i = 1}^{N} {x}_{i}}{N} \qquad Equation 14$$

and sample variance is given by:

$${\hat{σ}}^{2} = \frac{{\sum }_{i = 1}^{N} {( {x}_{i} - \hat{x} )}^{2}}{N - 1} . \qquad Equation 15$$

The signal-to-noise ratio (SNR) for the measurement is given by:

$$S N R = \frac{{E [ \hat{x} ]}^{2}}{E [ {\hat{σ}}^{2} ]} . \qquad Equation 16$$

In the case of MBL, it is given by:

$$S N {R}_{M B L} = \frac{N {μ}^{2}}{{σ}^{2}} . \qquad Equation 17$$

Even if the samples are drawn from any given probability distribution the definition of SNRₘₑₐₙ holds. Whereas the variance of the sample variance becomes a function of fourth order moment and is estimated to be:

$$E [ {( {\hat{σ}}^{2} - {σ}^{2} )}^{2} ] = {σ}^{4} [ \frac{2}{( N - 1 )} + \frac{κ}{N} ] \qquad Equation 18$$

where κ is the kurtosis of the probability distribution. A generalized expression for SNRᵥₐᵣ is given as:

$$S N {R}_{V B L} = \frac{1}{\frac{2}{( N - 1 )} + \frac{κ}{N}} . \qquad Equation 19$$

It can be seen that SNR_{MBL}, shown in Equation 17, increases with increase in μ and N and with the decrease in variance (σ²). On the other hand, SNR_{VBL} as expressed in Equation 19 is independent of parameter σ and only increases with N.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. A variance-based logic circuit comprising:
a measurement module configured receive an input signal and measure a first statistical variance of the input signal about a base value; and
a transformation module configured to generate an output signal having a second statistical variance about the base value based at least in part on the first statistical variance.

2. The variance-based logic circuit of claim 1, wherein the measurement module comprises a rectifier.

3. The variance-based logic circuit of claim 1, wherein the measurement module comprises a peak detector.

4. The variance-based logic circuit of claim 1, wherein
the variance-based logic circuit comprises a logical inverter;
the transformation module is configured to generate the output signal with the second statistical variance being greater than a threshold variance when the measurement module measures the first statistical variance below the threshold variance; and
the transformation module is configured to generate the output signal with the second statistical variance being less than the threshold variance when the measurement module measures the first statistical variance is above the threshold variance.

5. The variance-based logic circuit of claim 1, wherein
the variance-based logic circuit comprises a NOR gate;
the input signal comprises a first input signal and a second input signal;
the transformation module is configured to generate the output signal with the second statistical variance being greater than a threshold variance when the measurement module measures a statistical variance of the first input signal and a statistical variance of the second input signal both being below the threshold variance; and
the transformation module is configured to generate the output signal with the second statistical variance being less than the threshold variance when the measurement module measures a statistical variance above the threshold variance for either of the first input signal or the second input signal.

6. The variance-based logic circuit of claim 1, wherein the first statistical variance and the second statistical variance each comprise a statistical variance above a threshold variance representing a logical HIGH signal or a statistical variance below the threshold variance representing a logical LOW signal.

7. The variance-based logic circuit of claim 1, wherein the base value is zero volts.

8. A variance-based processor comprising:
a substrate; and
a plurality of logic gates on the substrate, each logic gate configured to perform binary logical operations based on signal variance about a base value, wherein the plurality of logic gates treat a signal variance greater than a threshold variance about the base value as a logical HIGH signal, and treat a signal variance less than the threshold variance about the base value as a logical LOW signal.

9. The variance-based processor of claim 8, wherein the plurality of logic gates are complementary metal-oxide-semiconductor (CMOS) based logic gates.

10. The variance-based processor of claim 8, wherein the plurality of logic gates comprise one or more of an inverter, a NAND gate, a NOR gate, a latch, and a D-flip-flop.

11. The variance-based processor of claim 8, wherein each logic gate of the plurality of logic gates comprises:
a measurement module configured receive an input signal and measure a first statistical variance of the input signal about a base value; and
a transformation module configured to generate an output signal having a second statistical variance about the base value based at least in part on the first statistical variance and a logical operation of the logic gate.

12. The variance-based processor of claim 11, wherein the measurement module comprises a rectifier.

13. The variance-based processor of claim 11, wherein the measurement module comprises a peak detector.

14. The variance-based processor of claim 11, wherein the variance-based processor is embedded in a structure.

15. The variance-based processor of claim 14, further comprising an input to receive power from a sensor in response to a vibration of the sensor by the structure.

16. The variance-based processor of claim 8, wherein the base value is zero volts.

17. A method of variance-based binary processing, where a variance of a signal greater than a threshold variance is a logical HIGH, and a variance of a signal less than a threshold is a logical LOW, the method comprising:
receiving an input signal;
determining, by a variance-based logic circuit, whether the input signal is a variance-based logical HIGH or a variance-based logical LOW; and
generating, by the variance-based logic circuit, an output signal based on a logical operation and whether the input signal is a variance-based logical HIGH or a variance-based logical LOW, the output signal being a variance-based logical HIGH or a variance-based logical LOW.

18. The method of claim 17, wherein the determining comprises measuring a first statistical variance of the input signal about a base value.

19. The method of claim 18, wherein the measuring comprises rectifying the input signal.

20. The method of claim 18, wherein the measuring comprises detecting a peak of the input signal.
